(19) United States
(12) Patent Application Publication
(10) Pub. No.: US 2007/0209303 A1
(43) Pub. Date: Sep. 13, 2007

(54) Organic electroluminescent device and the manufacturing method

(76) Inventors: Ryo Shoda, Tokyo (JP); Eiichi Kitazume, Tokyo (JP); Hajime Yokoi, Tokyo (JP); Yuko Abe, Tokyo (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/595,144

(22) Filed: Nov. 10, 2006

(30) Foreign Application Priority Data
Mar. 7, 2006 (JP) 2006-061829

(51) Int. Cl. E06B 7/00

(52) U.S. Cl. 52/204.593

(57) ABSTRACT

An organic electroluminescence device is provided including a luminescent medium layer, wherein the luminescence medium layer includes plural layers, wherein the plural layers includes a low molecular material layer comprising low molecular material and a high molecular material layer comprising high molecular material, and wherein at least one low molecular material layer is directly formed on at least one high molecular materials layer.

### CROSS REFERENCE

This application claims priority to Japanese application number 2006-061829, filed on Mar. 7, 2006, which is incorporated by reference.

### BACKGROUND OF THE INVENTION

1. Field of the Invention

The present invention is related to an organic electroluminescent device and the manufacturing method of the same.

2. Description of the Related Art

An organic electroluminescent device is explained below.

A transparent electrode layer is formed on a transparent substrate. Thereupon, a luminescent medium layer is formed. Thereupon, a counter electrode layer is formed.

The transparent electrode is used as an anode. The counter electrode is used as a cathode.

Because light is taken out while electrifying an organic luminescent layer, there are a transparent electrode and a counter electrode on either side of an organic luminescent layer.

When a conductive organic luminescent layer is electrified, the electron and the hole which are poured for the organic luminescent layer recombines. In the case of this recombination, organic luminescent material comprising an organic luminescent layer emits light.

The luminescent medium layer has plural layers. These plural layers include an organic luminescent layer comprising an organic electroluminescent material. For example, a hole transport layer, a hole injection layer, an electron transport layer and an electron injection layer are further included in a luminescent medium layer.

In many cases, the plural layers of the luminescent medium layer comprise a low molecular material having an average molecular weight less than 1,000 Daltons. For example, a hole injection layer consists of copper phthalocyanine (CuPc) and the like. A hole transport layer can be formed by N,N′-diphenyl-N, N′-bis(3-methylphenyl) 1-1′biphenyl-4,4′ diamine (TPD) and the like. A luminous layer can be formed by tris(8-quinolinol) aluminium (Alq3) and the like.

Generally, as for these layers formed by low molecular materials, thickness is about 1-100 nm.

These layers are formed by vacuum evaporation methods such as a resistance heating method and a sputter method. Or these layers are formed by wet process applying a coating liquid which the above mentioned material is dissolved in a solvent. In comparison with a vacuum evaporation method and a sputter method, facilities of wet process are inexpensive. In addition, as for wet process, upsizing is possible. In wet process, thin film can be formed under the atmosphere. In wet process, productivity is high.

However, thin film comprising the above mentioned low molecular material is unstable. Crystallization and cohesion of this thin film may occur by heat which occurs during a drive of an organic electroluminescent device. In addition, crystallization and cohesion of this thin film occur when an organic electroluminescent is just stored without making an organic electroluminescent device emit light. When partial crystallization and cohesion occur once, crystallization may spread in the whole of thin film. In other words it can be cloudy.

In addition, homogeneity of thin film falls when crystallization and cohesion occur. Therefore, luminous efficiency falls.

In addition, luminescent unevenness occurs.

In addition, a crystal becomes an origin, and a pinhole occurs in a device.

Therefore short-circuit occurs.

As thus described crystallization and cohesion cause luminous efficiency reduction and life time reduction of a device.

Especially, the layer formed with the use of low molecular material by wet process is easy to be crystallized.

Therefore that a crystallization preventing layer is provided around a luminescent part of an organic electroluminescent device is proposed (Japanese Patent Laid-Open No. 2004-127531 Official Gazette, Japanese Patent Laid-Open No. 7-192874 Official Gazette).

However, the method disclosed by Japanese Patent Laid-Open No. 2004-127531 Official Gazette cannot prevent crystal and cohesion in a luminescent part from occurring.

In addition, in method disclosed by Japanese Patent Laid-Open No. 7-192874 Official Gazette, low molecular material is scattered in a polymeric binder. Crystallization is prevented in this way. However, the material which can be used in this method is limited. Therefore, selection of material is difficult.

If each of plural layers included in the luminescent medium layer is formed by high molecular materials having weight average molecular weight higher than 1,000 Daltons, crystallization and cohesion are hard to occur. In addition, especially an organic luminescent layer should be formed by high molecular materials having weight average molecular weight higher than 1,000 Daltons.

However, as for high molecular materials, the width of face of ingredient selection is narrow as compared to low molecular materials.

Even more particularly, luminescent property of an organic electroluminescent device which an organic luminescent layer is formed using a high molecular material is inferior compared with that using a low molecular material.

### SUMMARY OF THE INVENTION

The present invention provides an organic electroluminescent device that crystallization and cohesion are hard to occur in the luminescent medium layer. In addition, the present invention provides an organic electroluminescent device of superior luminescent property. An organic electroluminescence device is provided including a luminescent medium layer, wherein the luminescence medium layer includes plural layers, wherein the plural layers includes a low molecular material layer comprising low molecular material and a high molecular material layer comprising high molecular material, and wherein at least one low molecular material layer is directly formed on at least one high molecular materials layer.

### BRIEF DESCRIPTION OF DRAWINGS

FIG. 1 is a sectional view of an organic electroluminescent device of an embodiment of the present invention.

FIG. 2 is a sectional view of an organic electroluminescent display device of passive matrix type of an embodiment of the present invention.

FIG. 3 is a schematic diagram which shows a relief duplicator used in the present invention.

FIG. 4 is a sectional view of an organic electroluminescent device of an embodiment of the present invention.

In these drawings, 100, 200 and 400 are each an organic electroluminescent device; 101, 201 and 401 are each a substrate; 102, 202 and 402 are each a first electrode layer; 103, 204 and 404 are each a luminescent medium layer; 103a, 204a and 404a are each a hole injection layer; 103b, 204b and 404b are each a hole transport layer; 103c, 204c and 404c are each an organic luminescent layer; 103d and 204d are each an electron transport layer; 103e, 204e and 404e are each an electron injection layer; 104, 205 and 405 are each a second electrode layer; 203 and 403 are each an insulator layer; 300 is a relief duplicator; 301 is an ink tank; 302 is an ink chamber; 303 is an anilox roll; 303a is an ink layer; 304 is a printing cylinder; 305 is a relief printing plate; 306 is a flat base; and 307 is a substrate.

### DESCRIPTION OF THE PREFERRED EMBODIMENTS

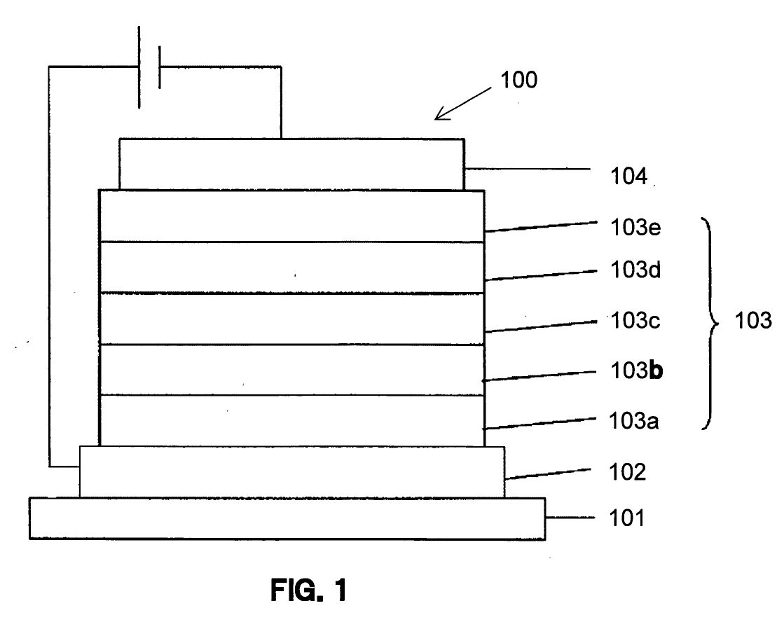

FIG. 1 is a sectional drawing of an organic electroluminescent device of an embodiment of the present invention. Organic electroluminescent device 100 comprises substrate 101, first electrode layer 102 formed on this substrate 101, luminescent medium layer 103 formed on this first electrode layer 102 and a second electrode layer 104 formed on this luminescent medium layer 103. First electrode layer 102 is a transparent electrode. The second electrode layer 104 is a counter electrode.

Substrate 101 is a transparent substrate. Various materials can be used for this substrate 101. For example, a glass substrate and a substrate comprising plastic film or sheet can be used. Especially, if the thin glass substrate of which thickness is about 0.2-1 mm is used, the thin organic electroluminescent device of which barrier property is very high can be made.

For material of a first electrode layer 102 which is a transparent electrode, any conductive materials for a transparent or semitransparent electrode can be used. For example, as oxide, complex oxide of indium and tin (ITO), complex oxide of indium and zinc (IZO), tin oxide, zinc oxide, indium oxide and zinc aluminium complex oxide can be used.

Above all, ITO has the following characteristics. Therefore, it is preferable.

1. low electrical resistance
2. solvent resistance
3. transparence

An evaporation method and a sputtering method can be used to form first electrode layer 102 on substrate 101 using the above mentioned material.

In addition, first electrode layer 102 can be formed using an application/thermal-decomposition method. In other words precursors such as octylic acid indium or acetone indium are applied on substrate 101. A layer of oxidate is formed by thermal decomposition afterwards.

A semitransparent layer may be formed by further depositing metallic material such as aluminium, gold and silver. Organic semiconductor such as polyaniline may be used. Other method can be used.

For first electrode layer 102, patterning may be performed by etching if necessary. The surface of first electrode layer 102 may be activated by UV processing or plasma treatment.

For material of the second electrode layer 104 which is a counter electrode, the following materials can be used:

### 1. Metal simple substance such as Mg, Al and Yb;

2. An alloy of a low work function metal and a stable metal, which can keep good balance between electron injection efficiency and stability. For example, alloys such as MgAg, AlLi and CuLi can be used.

As for the formation method of a counter electrode, depending on the material of the counter electrode, a resistance heating evaporation method, an electron beam method and a sputtering method can be used.

It is desirable for thickness of a counter electrode to be about 10 nm-1,000 nm.

Organic electroluminescent device 100 has a sealing medium comprising a glass cap and adhesive and the like to protect luminescent medium layer 103 from outside oxygen and moisture. This sealing medium is not illustrated in FIG. 1. In addition, in the case of flexible substrate 101, flex film is used as a sealing medium.

Luminescent medium layer 103 is a laminate including plural layer 103a-103e. These plural layers include hole injection layer 103a, hole transport layer 103b, organic luminescent layer 103c, electron transport layer 103d and electron injection layer 103e.

In addition, structure of the luminescent medium layer of an organic electroluminescent device of the present invention is not limited to the illustrated structure. Structure of the luminescent medium layer may be other structure. The luminescent medium layer may further comprise a hole blocking layer or an insulator layer. In addition, the luminescent medium layer does not need to have all of illustrated layer 103a-103e. But organic luminescent layer 103c is a necessary layer.

It is necessary for luminescent medium layer 103 to include organic luminescent layer 103c and one or more other layer(s) to improve luminous effect. And, in the present invention, plural layers having luminescent medium layer 103 include a low molecular material layer comprising a low molecular material and a high molecular material layer comprising a high molecular material. Therefore, an organic electroluminescent device having a superior characteristic is obtained.

In the present invention, a low molecular material means a material having a weight average molecular weight less than about 1,000 Daltons. In addition, a high molecular material means a material having weight average molecular weight is higher than about 1,000 Daltons.

Luminescent medium layer 103 includes at least one low molecular material layer and at least one high molecular material layer. And a low molecular material layer contacts a high molecular material layer. More preferably, structure of luminescent medium layer 103 is a structure having three or more layers in that one low molecular material layer is sandwiched between two high molecular material layers.

In the case of the above mentioned structure, crystallization and cohesion of a low molecular material layer can be prevented. In addition, while driving an organic electroluminescent device, deterioration can be prevented and becoming highly resistive can be prevented. In other words a device of long life can be obtained. In addition, especially, in the case of the structure that a low molecular material layer is sandwiched between high molecular material layers, both sides of a low molecular material layer touch the amorphous surfaces of high molecular material layers. Therefore, the above mentioned advantageous effect is achieved more.

Five layers 103a-103e shown in FIG. 1 may be low molecular material layers. In addition, these five layers may be high molecular material layers.

In addition, thickness of these layers 103a-103e can vary. However, as for each layer thickness, preferably it can be 10-100 nm. It is preferable for total film thickness of luminescent medium layer 103 to be 80-500 nm.

About each of layers 103a-103e included in luminescent medium layer 103, material and formation method are explained below.

For material of hole injection layer 103a or hole transport layer 103b, material generally employed as hole injection material or hole transport material can be used.

When hole injection layer 103a or hole transport layer 103b is a low molecular material layer, the following material is used:

Copper phthalocyanine and the derivative, 1,1-bis(4-di-p-tolylamino phenyl) cyclohexane, N,N′-diphenyl-N,N′-bis(3-methylphenyl)-1,1′-biphenyl-4,4′-diamine and aromatic amine system such as TPD can be used.

Hole injection layer 103a or hole transport layer 103b which is a low molecular material layer can be formed by a vacuum evaporation method using these material.

In addition, other method is described below.

Coating liquid (hole injection material ink or hole transport material ink) is made by dissolving the above mentioned material in solvent. For a solvent, toluene, xylene, acetone, anisole, methyl anisole, dimethylanisole, benzoic ether, methyl benzoate, mesitylene, Tetralin, amyl benzene, methyl ethyl ketone, methyl isobutyl ketone, cyclohexanone, methanol, ethanol, isopropanol, ethyl acetate, butyl acetate and water can be used. In addition, mixed solvent comprising the above mentioned material can be used. Hole injection layer 103a or hole transport layer 103b which is a low molecular material layer can be formed by the wet process using the coating liquid.

On the other hand, when hole injection layer 103a or hole transport layer 103b which is a high molecular material layer is formed, the following material can be used:

Polyaniline, polythiophene, polyvinyl carbazole, a mixture with poly(3,4-ethylenedioxy thiophen) and polystyrene sulfonate, PPV (polyparaphenylene vinylene) derivative and PAF derivative can be used.

Coating liquid (hole injection material ink or hole transport material ink) is made by dissolving these materials in a solvent.

For a solvent, toluene, xylene, acetone, methyl ethyl ketone, methyl isobutyl ketone, cyclohexanone, methanol, ethanol, isopropanol, ethyl acetate, butyl acetate and water can be used. Mixed solvent comprising these materials can be used, too.

Hole injection layer 103a or hole transport layer 103b which is a high molecular material layer can be formed by the wet process using the coating liquid.

Organic luminescent layer 103c can be formed by a material generally used as an organic luminescent material. When organic luminescent layer 103c is a low molecular material layer, the following material can be used:

Coumarin system, perylene system, pyran system, anthrone system, PORUFIREN system, quinacridon system, N,N′-dialkyl permutation quinacridon system, naphthalimido system and N,N′-diaryl permutation pyrrolo pyrrole series;

The well-known fluorescent low molecular material which can emit light from singlet state; and

The well-known phosphorescence low molecular material of rare earth metal complex system which can emit light from a triplet state.

Organic luminescent layer 103c which is a low molecular material layer can be formed by a vacuum evaporation method using these materials.

In addition, other method is described below.

Coating liquid (organic luminescent material ink) is made by dissolving these materials in solvent. For a solvent, toluene, xylene, acetone, anisole, methyl anisole, dimethylanisole, benzoic ether, methyl benzoate, mesitylene, Tetralin, amyl benzene, methyl ethyl ketone, methyl isobutyl ketone, cyclohexanone, methanol, ethanol, isopropanol, ethyl acetate, butyl acetate and water can be used. In addition, mixed solvent comprising these materials can be used, too. Organic luminescent layer 103c which is a low molecular material layer can be formed by the wet process using the coating liquid.

On the other hand, when organic luminescent layer 103c is a high molecular material layer, the following materials can be used:

Coumarin system, perylene system, pyran system, anthrone system, PORUFIREN system, quinacridon system, N,N′-dialkyl permutation quinacridon system and naphthalimido system;

The material which fluorescent pigments such as N,N′-diaryl permutation pyrrolo pyrrole series is dissolved in macromolecules such as polystyrene, polymethyl methacrylate and polyvinyl carbazole.

In addition, a macromolecular fluorescene body such as PPV system and PAF system and macromolecule luminous bodies such as macromolecule phosphorescence luminous bodies including a rare earth metal complex can be used.

Coating liquid (organic luminescent material ink) is made by dissolving these macromolecular organic luminescent materials in a solvent. For a solvent, toluene, xylene, acetone, anisole, methyl anisole, dimethylanisole, benzoic ether, methyl benzoate, mesitylene, Tetralin, amyl benzene, methyl ethyl ketone, methyl isobutyl ketone, cyclohexanone, methanol, ethanol, isopropanol, ethyl acetate, butyl acetate and water can be used. In addition, mixed solvent comprising these materials can be used. Organic luminescent layer 103c which is a high molecular material layer can be formed by the wet process using the coating liquid. Among these solvents, as for toluene, xylene, anisole, methyl anisole, dimethylanisole, benzoic ether, methyl benzoate, mesitylene, Tetralin and aromatic series solvent such as amyl benzene, solubility of macromolecule organic luminescent material is especially preferable. In addition, handling is easy, too. Therefore, these solvents are more preferable.

For a hole block material or an electron transport material forming a hole blocking layer or an electron transport layer 103d, the material which is generally employed as a hole block material or an electron transport material can be used.

When a hole blocking layer or an electron transport layer 103d is a low molecular material layer, the following materials can be used:

Low molecular materials such as triazole series, oxazole system, oxadiazole system, silole system and boron system can be used.

A Hole blocking layer or an electron transport layer 103d which is a low molecular material layer can be formed by a vacuum evaporation method using these materials.

On the other hand, method to form a hole blocking layer or an electron transport layer 103d which is a high molecular material layer is explained below.

A hole block material or an electron transport material which is a low molecular material is dissolved in high molecular materials such as polystyrene, polymethyl methacrylate and polyvinyl carbazole.

Coating liquid (hole block material ink or electron transport material ink) is made by further dissolving it in a solvent. For a solvent, toluene, xylene, acetone, methyl ethyl ketone, methyl isobutyl ketone, cyclohexanone, methanol, ethanol, isopropanol, ethyl acetate, butyl acetate and water can be used. In addition, mixed solvent comprising these materials can be used, too.

A hole blocking layer or an electron transport layer 103d which is a high molecular material layer can be formed by the wet process using the coating liquid.

For electron injection materials used for electron injection layer 103e, low molecular material used for electron transport layer 103d, alkali metal such as lithium fluoride or lithium oxide or, salt or oxide of alkaline earth metals can be used.

Electron injection layer 103e which is a low molecular material layer can be formed by a vacuum evaporation method using these materials.

On the other hand, method to form electron injection layer 103e which is a high molecular material layer is described below.

The above mentioned low molecular material is dissolved in high molecular materials such as polystyrene, polymethyl methacrylate and polyvinyl carbazole.

Coating liquid (electron injection material ink) is made by further dissolving it in a solvent. For a solvent, toluene, xylene, acetone, methyl ethyl ketone, methyl isobutyl ketone, cyclohexanone, methanol, ethanol, isopropanol, ethyl acetate, butyl acetate and water can be used. In addition, mixed solvent comprising these materials can be used, too.

Electron injection layer 103e which is a high molecular material layer can be formed by the wet process using the coating liquid.

Like statement above, all of plural layer 103a-103e which are low molecular material layers included in luminescent medium layer 103 can be formed by a vacuum evaporation method and wet process. But in many cases wet process is preferable. Facilities of wet process are inexpensive. Upsizing of wet process is possible. Wet process can form a layer under the atmosphere. In addition, wet process can form a layer efficiently and fast.

In addition, as wet process, there are application method and printing method. In application method, there is application method using a spin coater, a bar coating machine, a roll coater, a die coating machine or a gravure coater. It is necessary for luminescent medium layer 103 to be patterned highly minutely when an organic electroluminescent device is a display device.

In application method, an extra process of patterning is needed after film formation. In printing method, film formation and patterning can be performed at the same time. Therefore, it is often that printing method is more convenient.

In printing method, there are relief printing, intaglio process, screen printing, photogravure process, flexography and offset printing. Above all, relief printing is desirable to manufacture an organic electroluminescent device from the viewpoint of following:

Relief printing is easy to fit for a viscosity area of normal coating liquid;

In relief printing, printing is performed without damaging a base material; and

In relief printing, utilizing efficiency of material is preferable.

A structure and a manufacturing procedure of an organic electroluminescent display device of the present invention are explained next.

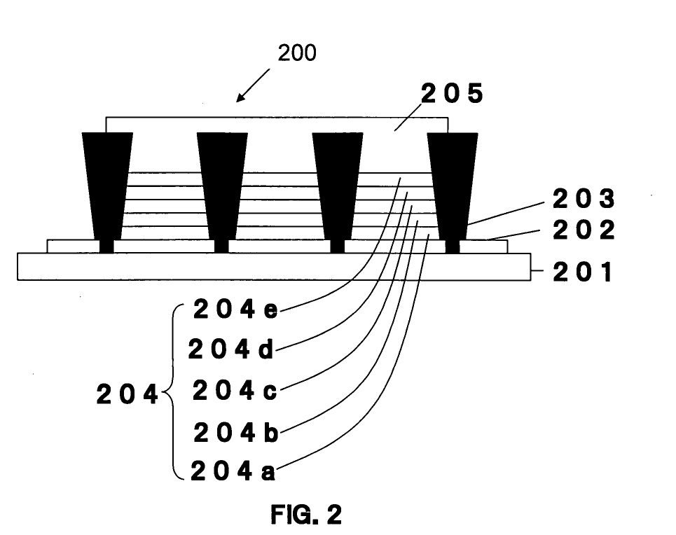

FIG. 2 is a sectional drawing which shows an example of an organic electroluminescent display device of passive matrix type of an embodiment of the present invention.

Organic electroluminescent display device 200 comprises substrate 201, first electrode layer 202 formed on this substrate 201, luminescent medium layer 204 formed on this first electrode layer 202 and second electrode layer 205 formed on this luminescent medium layer 204. First electrode layer 202 is a transparent electrode. Second electrode layer 205 is a counter electrode.

The transparent electrode that is first electrode layer 202 includes a lot of line-shaped pixel electrodes. Insulator layer 203 is formed between two adjacent pixel electrodes. Pattern-shaped luminescent medium layer 204 is formed on pixel electrodes. The line-shaped counter electrode which is second electrode layer 205 is perpendicular to pixel electrodes.

Luminescent medium layer 204 of FIG. 2 includes plural layer 204a-204e. Plural layers include hole injection layer 204a, hole transport layer 204b, organic luminescent layer 204c, electron transport layer 204d and electron injection layer 204e.

Substrate 201 is a transparent substrate. The first electrode layer 202 which is a transparent electrode comprising a lot of line-shaped pixel electrodes is formed on this substrate 201. Successively, insulator layer 203 is formed between adjacent pixel electrodes by photolithography method using a photosensitive material.

It is desirable for height of insulator layer 203 to be 0.5 μm-5.0 μm.

When hole injection layer 203a is formed, insulator layer 203 between adjacent pixel electrodes controls spreading of hole transport material ink printed on each pixel electrodes. Therefore, insulator layer 203 prevents leakage current between pixel electrodes. When this insulator layer 203 is not sufficiently high, spreading of hole transport material ink cannot be controlled. In other words the hole injection layer is formed on an insulator layer. Therefore, leakage current cannot be prevented. Therefore it is desirable for height of insulator layer 203 to be more than 0.5 μm. In an organic electroluminescent display device of passive matrix type, a counter electrode is formed over an insulator layer between pixel electrodes. When an insulator layer is too high, there is danger that breaking of a counter electrode occurs. It is desirable for height of an insulator layer to be equal to or less than 5.0 μm.

For a photosensitive material forming insulator layer 203, various commercial resist materials can be used. Both positive type resist and negative type resist can be used. Resist material having insulating properties is used. In the case of a resist material which does not have insulating properties, an electric current flows between the adjacent pixel electrodes through the resist material. Therefore, display fault occurs. For a resist material for an insulator layer, a resist material of a polyimide system, an acryl resin system and a novolac resin system can be used. In addition, light shielding material may be incorporated into a photosensitive material for insulator layer 203 for the purpose of improving display quality of an organic electroluminescent display device. Ink repellent material may be further incorporated into the photosensitive material to prevent hole transport material ink from spreading to an insulator layer.

The above mentioned resist material is applied to substrate 201 on which the first electrode layer 202 is formed by application method with the use of a spin coater, a bar coating machine, a roll coater, a die coating machine, a gravure coater and the like. And patterning by photolithography method is performed. In the case of application method with the use of a spin coater, a layer of desired film thickness may not be obtained by one application. In that case, a similar process should be repeated multiple times. In addition, ink repellent characteristics of insulator layer 203 can be adjusted by performing process such as plasma cleaning and UV cleaning on insulator layer 203 formed in this way.

After formation of insulator layer 203, hole injection layer 204a, hole transport layer 204b, luminescent layer 204c, electron transport layer 204d and electron injection layer 204e included in luminescent medium layer 204 are formed sequentially. It is preferable for these layer 204a-204e to be formed by wet process. It is especially desirable for these layers to be formed by relief printing.

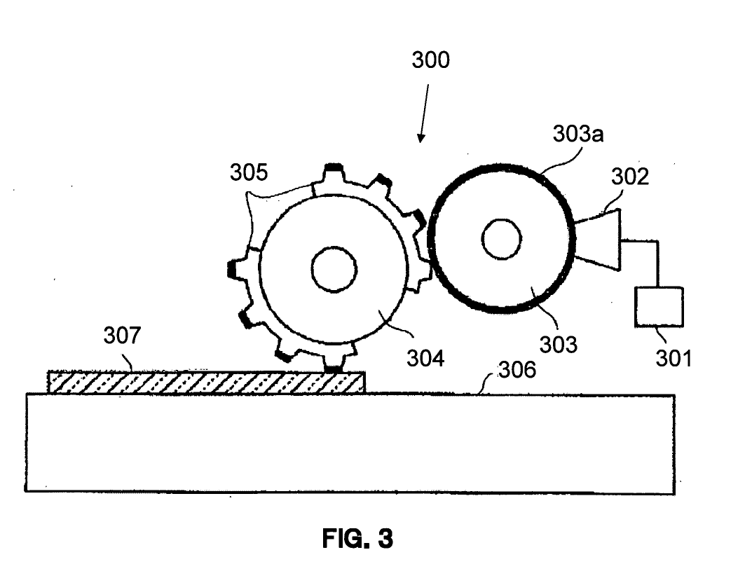

A schematic diagram of a relief duplicator is shown in FIG. 3.

Coating liquid (hole injection material ink, hole transport material ink, organic luminescent material ink, electron transport material ink and electron injection material ink) to form layer 204a-204e is pattern-printed on a substrate on which pixel electrodes and an insulator layer are formed.

Relief duplicator 300 comprises ink tank 301, ink chamber 302, anilox roll 303, printing cylinder 304 on which relief printing plate 305 is mounted and flat base 306 on which substrate 307 is put.

Various coating liquid is stored in ink tank 301 respectively. The coating liquid is sent into ink chamber 302 from ink tank 301. Anilox roll 303 is supported rotatably. Ink is supplied from an ink feed section of ink chamber 302 to a surface of this anilox roll 303. And, by a rotation of anilox roll 303, ink supplied on a surface of this anilox roll 303 becomes ink layer 303a of uniform film thickness.

Printing cylinder 304 is placed near anilox roll 303. Printing cylinder 304 is rotationally driven by an unillustrated driving mechanism. Ink layer 303a formed on a surface of anilox roll 303 transfers on projection parts of relief printing plate 305 mounted on this printing cylinder 304. Substrate 307 on which a transparent electrode and an insulator layer are formed is put on flat base 306. Substrate 307 may have a luminescent medium layer as a lower layer. This substrate 307 is transported by unillustrated transporting means. And substrate 307 passes a printing position. And ink on projection parts of relief printing plate 305 is printed on substrate 307. In addition, ink is dried if necessary. A layer is formed on substrate 307 in this way.

In organic electroluminescent display device 200 of FIG. 2, plural layer 204a-204e of luminescent medium layer 204 includes a low molecular material layer comprising a low molecular material having a weight average molecular weight less than 1,000 Daltons and a high molecular material layer comprising a high molecular materials having weight average molecular weight higher than 1,000 Daltons. Therefore an organic electroluminescent display device having a superior characteristic is obtained. In other words, luminescent medium layer 204 has at least one low molecular material layer and at least one high molecular material layer. And a low molecular material layer contacts a high molecular material layer. More preferably, structure of an organic electroluminescent display device is structure having 3 or more layers and one low molecular material layer is sandwiched between two high molecular material layers. Organic electroluminescent device 200 of FIG. 2 has the merit which is similar to the merit which organic electroluminescent device 100 of FIG. 1 has.

The second electrode layer 205 which is a counter electrode is formed successively. For material of the second electrode layer 205, metal simple substance such as Mg, Al and Yb can be used. Alloy system of a low work function metal and a stable metal which can balance electron injection efficiency and stability can be used. For example, alloys such as MgAg, AlLi and CuLi can be used. For formation method of a counter electrode, depending on the material of a counter electrode, a resistance heating evaporation method, an electron beam method and a sputtering method can be used. It is desirable for thickness of a counter electrode (thickness of the second electrode layer 205) to be about 10 nm-1,000 nm.

Organic electroluminescent display device 200 equips a sealing medium comprising a glass cap and adhesive and the like to protect luminescent medium layer 204 from outside oxygen and moisture. A sealing medium is not illustrated in a schematic view of FIG. 2. In addition, a flex film can be used as a sealing medium when substrate 201 is flexible.

In addition, it is preferable for plate 305 to use a light-sensitive resin relief printing plate. When a light-sensitive resin relief printing plate is used, a highly accurate plate can be easily formed. As a liquid developer for an exposed resin, there is organic solvent and water. Solvent developing type photosensitive resin plate withstands water type ink. Water-developable photosensitive resin plate withstands organic solvent system ink. Therefore, according to a kind of solvent in coating liquid (ink), type of light-sensitive resin relief printing plate should be selected properly.

According to the current invention, crystallization and cohesion of a low molecular material layer can be prevented. The present invention can prevent deterioration of an organic electroluminescent device and can prevent an organic electroluminescent device from becoming highly resistive, during driving of an organic electroluminescent device. Therefore, a device of long life is obtained. In addition, especially, in the case of the structure that a low molecular material layer is sandwiched between high molecular material layers, both sides of a low molecular material layer touch amorphous surface of high molecular material layers. Therefore, more advantageous effect is obtained. Further the occurrence of a pinhole, a dark spot and leak of an electric current is prevented because crystallization and cohesion of a low molecular material layer are controlled. And the width of face of the configuration of luminescent medium layer spreads. The width of face of the manufacturing method of luminescent medium layer spreads. The width of the selection of the material for luminescent medium layer is widened. Therefore, an organic electroluminescent device and an organic electroluminescent display device of long life of which luminous efficiency and luminescent ruminant are superior are obtained.

### EXAMPLE 1

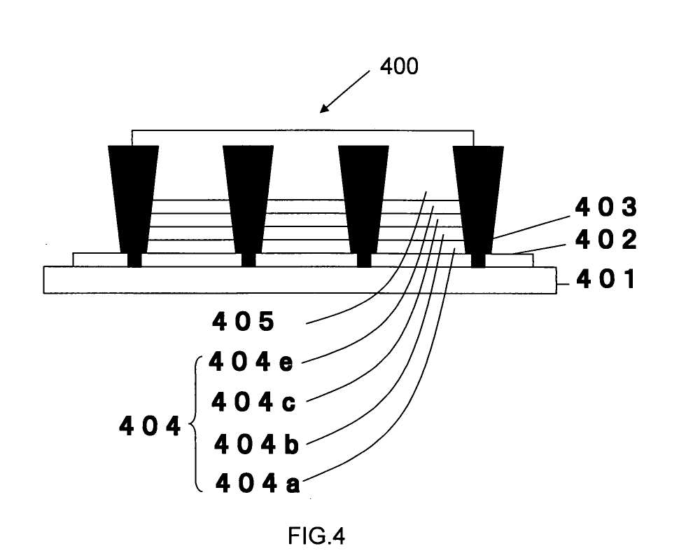

A glass substrate shown in FIG. 4 was used for substrate 401. The thickness of substrate 401 was 0.7 mm. The length of a diagonal of substrate 401 was 1.8 inches. On this substrate 401, ITO film was formed by a sputter method. Patterning of the ITO film was performed by photolithography method and etching using an acid solution. First electrode layer 402 which was a transparent electrode (pixel electrodes) was formed in this way. Line pattern of pixel electrodes is described below.

The line widths were 136 μm. The space between lines was 30 μm. There were 192 lines in about 32 mm width.

Next insulator layer 403 was formed as follows.

At first modacrylic photoresist material was applied by a spin coat to a whole area of substrate 401 on which pixel electrodes 402 was formed.

A condition of this spin coat is described below.

It is rotated for five seconds at 150 rpm. Afterwards it is rotated for 20 seconds at 500 rpm.

The number of times of coating was only once.

The height of an insulator layer which was formed in this way was 1.5 μm. Patterning of the photoresist material which was applied in this way to a whole area of substrate 401 was performed by a photolithography method. Line-shaped insulator layer 403 was formed between pixel electrodes in this way.

Next copper phthalocyanine (CuPc) was formed between insulator layer 403 and insulator layer 403 by a vacuum evaporation method. Hole injection layer 404a which was a low molecular material layer of 20 nm thickness was formed in this way.

Coating liquid (hole transport material ink) was made next. Triphenylamines was used as a hole transport material. The weight average molecular weight of triphenylamines was 800. As a solvent, cyclohexanol was used. The concentration of triphenylamines was one % by weight. This coating liquid was printed by relief printing to the line-shaped pixel electrodes between insulator layer 403 and insulator layer 403. Hole transport layer 404b which was a low molecular material layer was formed in this way.

In this case, an anilox roll of 150 line/inch and water-developable photosensitive resin plate were used.

The thickness of hole transport layer 404b after drying was 30 nm.

Coating liquid (organic luminescent material ink) was made next. The PPV (polyparaphenylene vinylene) derivative which was an organic luminescent material of a high molecular material was used. The weight average molecular weight of a PPV (polyparaphenylene vinylene) derivative was 100000. For a solvent, mixed solvent comprising xylene 85% and anisole 15% was used. The concentration of a PPV (polyparaphenylene vinylene) derivative was one % by weight.

By relief printing using this coating liquid, pattern-shaped organic luminescent layer 404c which was a high molecular material layer of 80 nm thickness was formed.

Next electron injection layer 404e (LiF) which was a low molecular material layer of 0.5 nm thickness was formed by a vacuum evaporation method.

Finally Al film was formed by a vacuum evaporation method. The second electrode layer 405 (the Al layer) which was a counter electrode of 150 nm thickness was formed in this way.

And sealing was performed using a glass cap and adhesive.

Organic electroluminescent display device of a passive drive type was obtained in this way.

In this passive organic electroluminescent display device, a short-circuit between pixel electrodes did not occur. In addition, only selected picture elements were illuminated. It was good display device without luminescent unevenness.

The luminance was 160 cd/m² at applied voltage of 6V.

In addition, the luminance half time was 1600 hours when initial luminance was 400 cd/m².

This passive organic electroluminescent display device was further left at temperature 85 degrees Celsius, air moisture 90% for 400 hours. Picture elements were observed by a microscope afterwards. A crystal precipitated partially. Several non-luminescent parts were confirmed.

### EXAMPLE 2

Example 2 was “example of modification” of example 1.

The structure of example 2 was the same structure as example 1 other than hole injection layer 404a.

Coating liquid (hole injection material ink) is explained below. PEDOT (poly (3,4-ethylenedioxy thiophen)) which was high molecular material was used. The weight average molecular weight of PEDOT was 300000. Water was used as a solvent. The concentration of PEDOT was one % by weight.

By relief printing using this coating liquid, pattern-shaped hole injection layer 404a which was a high molecular material layer of 40 nm thickness was formed. Therefore, hole transport layer 404b which was a low molecular material layer was sandwiched between hole injection layer 404a and organic luminescent layer 404c which were high molecular material layers.

In this passive organic electroluminescent display device, a short-circuit between pixel electrodes did not occur. Only selected picture elements were illuminated. It was good display device without luminescent unevenness.

The luminance was 150 cd/m² at applied voltage of 6V.

In addition, the luminance half time was 2000 hours when initial luminance was 400 cd/m².

This passive organic electroluminescent display device was further left at temperature 85 degrees Celsius, air moisture 90% for 400 hours. Picture elements were observed by a microscope afterwards. There was not the non-luminescent part due to crystalline precipitation. Only selected picture elements were illuminated. There was not the luminescent unevenness.

### COMPARATIVE EXAMPLE

The structure of comparative example was the same structure as example 1 other than organic luminescent layer 404c.

Coating liquid (organic luminescent material ink) is described below. The perylenes which was low molecular material was used. The weight average molecular weight of perylenes was 800. As a solvent, mixed solvent comprising xylene 85% and anisole 15% was used. The concentration of perylenes was one % by weight.

By relief printing using this coating liquid, pattern-shaped organic luminescent layer 404c which was a high molecular material layer of 80 nm thickness was formed. Therefore, all layers of 404a, 404b and 404c were low molecular material layers. There was not a high molecular materials layer.

The luminance of this passive organic electroluminescent display device was 170 cd/m² at applied voltage of 6V. However, there were a lot of cloudy parts. In addition, short circuit occurred. Therefore, it was difficult to illuminate only selected picture elements.

Generally, for material of a layer, the number of kinds of low molecular materials is more than that of high molecular materials. In addition, the transport of electron or hole smoothens by forming multilayered low molecular material. Therefore, recombination probability improves. Therefore, in the case of the organic electroluminescent device with the use of a low molecular material, improvement in luminous efficiency and a device life time is expected, in comparison with an organic electroluminescent device with the use of a high molecular material. However, after formation of a low molecular material layer, cohesion and crystallization occur. There is danger that electric current leak, a short-circuit and a dark spot occur. When a low molecular material layer was formed by wet process, these defect tends to occur conspicuously.

Therefore, in the present invention, a high molecular material layer that cohesion is hard to occur is formed in the surface of a low molecular material layer. Therefore, the occurrence of crystallization and cohesion in the surface of a low molecular material layer is controlled. Therefore a layer can be formed by wet process using low molecular material. An organic electroluminescent display device of large screen can be manufactured easily by adopting a wet process. In addition, productivity of an organic electroluminescent device can be improved conspicuously by using relief printing among wet process.

What is claimed is:

1. An organic electroluminescence device including a substrate, a first electrode layer formed on the substrate, a luminescent medium layer formed on the first electrode layer and a second electrode layer formed on the luminescence medium layer,
wherein the first electrode layer or the second electrode layer is a transparent electrode or a counter electrode,
wherein the luminescence medium layer includes plural layers,
wherein the plural layers includes an organic luminescent layer comprising an organic electroluminescence material,
wherein the plural layers includes a low molecular material layer comprising a low molecular material and a high molecular material layer comprising a high molecular material, and
wherein at least one low molecular material layer is directly formed on at least one high molecular material layer.

2. The organic electroluminescence device according to claim 1,
wherein a low molecular material layer is sandwiched between two high molecular material layers.

3. The organic electroluminescence device according to claim 1,
wherein the device is a display device.

4. A manufacturing method of an organic electroluminescence device including a substrate, a first electrode layer formed on the substrate, a luminescent medium layer formed on the first electrode layer and a second electrode layer formed on the luminescence medium layer,
wherein the first electrode layer or the second electrode layer is a transparent electrode or a counter electrode,
wherein the luminescence medium layer includes plural layers,
wherein the plural layers includes an organic luminescent layer comprising an organic electroluminescence material,
wherein the plural layers includes a low molecular material layer comprising low molecular material and a high molecular material layer comprising a high molecular material, and
wherein at least one low molecular material layer is directly formed on at least one high molecular material layer,
said method includes forming the low molecular material layer by a wet process.

5. The manufacturing method of an organic electroluminescence device according to claim 4, wherein the wet process comprises relief printing.
